(19) United States
(12) Patent Application Publication
(10) Pub. No.: US 2008/0011266 A1
(43) Pub. Date: Jan. 17, 2008

(54) Device For Transmitting A Torque And Method For Producing A Device For Transmitting A Torque

(76) Inventors: Hans Staudenmaier, Waiblingen (DE); Daniel Damson, Weissach (DE); Wolfram Hasert, Weinstadt (DE); Matthias Jaeger, Madrid (ES); Angel Luis Castillo Redondo, Aranjuez (ES); Alfonso Martinez Lesma, Aranjuez (ES)

Correspondence Address: MICHAEL J. STRIKER, 103 EAST NECK ROAD, HUNTINGTON, NY, 11743, US

(21) Appl. No.: 11/568,728

(22) PCT Filed: Jun. 28, 2005
(86) PCT No.: PCT/EP05/53018

§ 371 Date: Nov. 6, 2006

(30) Foreign Application Priority Data
Jun. 30, 2004 (DE) 102004031852.2

(51) Int. Cl. F02B 77/14

(52) U.S. Cl. 123/198 R; 474/273

(57) ABSTRACT

The present invention relates to a device for transmitting a torque, in particular a pulley connected to an internal combustion engine for transmitting a torque from the internal combustion engine to an accessory, a rotor (10) being rotatably connected with a bearing part (20) of a bearing.

According to the invention, the rotor (10) and a circumferential surface (21) of the bearing are at least partially connected via an adhesive bond (25). The invention also relates to a method for producing the device.

### RELATED ART

The present invention is based on a device for transmitting a torque, and a method for producing a device for transmitting a torque, according to the definitions of the species in Claims 1 and 9.

Publication DE 198 60 150 A1 makes known a device for transmitting a torque from an internal combustion engine to a compressor, with which a pulley is rotatably supported on a compressor housing via a roller bearing. To connect—in a form-fit and non-positive manner—a driving disk capable of being rotated with the pulley, and a hub of the compressor, profiling is provided on their circumferential contact surfaces, which is designed such that the driving disk becomes rotatably movable on the hub when torque increases, e.g., when the compressor becomes blocked. To produce a non-positive connection using profiling, the components must be machined to a considerable extent.

### ADVANTAGES OF THE INVENTION

In contrast, an inventive device for transmitting a torque with a rotor is provided, the rotor being rotatably connected with a bearing part of a bearing, with which the rotor and a circumferential surface of the bearing are at least partially connected via an adhesive bond. The bearing is a roller bearing, in particular. The adhesive bond ensures transmission of axial forces, which are usually multifold weaker than radial forces that occur. The size of areas, particularly gaps between the rotor and the circumferential surface, where the adhesive bond is provided, and the elasticity of the adhesive are advantageously selected such that damage to the adhesive bond can be prevented over the entire temperature range during operation of the device. Adhesives based on epoxy resin are preferred; they have greater elasticity than, e.g., anaerobic adhesives, and they can fill greater gap widths. Depending on the application conditions, other adhesives can also be suitable, however.

When the rotor includes ribs on its side facing the bearing part of the bearing, which are positioned separately around the circumference and point toward the roller bearing, contact areas for a non-positive connection with the circumferential surface of the bearing can be advantageously formed, and areas can be formed that are suitable for the adhesive bonds. The ribs are preferably formed on an inner circumference of the rotor such that the rotor surrounds the bearing. It is also feasible that, as an alternative, the ribs are formed on an outer circumference, and the rotor is located inside the bearing.

The rotor is preferably made of a plastic. Using a suitable manufacturing method, profiling of the rotor in this manner can be carried out using simple tools. The laborious steps of remachining of a bearing seat in the rotor can be eliminated.

Advantageously, the adhesive bond is located in recesses between the ribs. Advantageously, all recesses are filled with adhesive. The ribs are preferably connected in a non-positive manner with the circumferential surface of the roller bearing.

In this manner, an advantageous, functional separation between radial and axial forces is attained. The radial forces are transmitted primarily via the ribs. These ribs or segments are in direct contact with the bearing outer race. The bearing seat is designed such that the ribs are always in contact with the ball bearing, at low temperatures and at high temperatures. The different thermal expansion coefficients of metal and plastic are taken into account, so that the radial forces can be absorbed by the ribs over the entire temperature range.

The axial forces that hold the roller bearing in its axial position are advantageously absorbed mainly via the adhesive bond. To this end, adhesive is inserted in the pockets and recesses between the ribs.

In this manner, the fact that adhesives are generally poorly capable of absorbing alternating tension-compression stresses—which is a technical problem—is taken into account.

There are basically no limitations on the circumferential surface ratio of recesses and ribs. In a preferred embodiment, the recesses have a wider circumference than the ribs.

Advantageously, ribs differ in terms of their width and their distribution around the circumference of the rotor; in particular, they are asymmetrical in design.

Any number of ribs, which serve as supporting areas, and any number of recesses, which serve as pockets for the adhesive, can be selected. The number of ribs is preferably a prime number, however. Likewise, the number of recesses is preferably a prime number, but it is at least uneven. A possible excitation of oscillation of a belt drive, which, e.g., has a drive connection with a rotor designed as a pulley, can therefore be advantageously interrupted.

The recesses and the ribs can have basically any type of geometric design. In a favorable embodiment, radii are provided in the rotor, which is preferably made of plastic, for transitions from recesses to ribs.

The bearing itself can have any geometric design, as can a bearing race, against the circumferential surface of which the rotor bears in a non-positive manner. It is advantageous to provide a reinforced bearing race on the side of the bearing against which the rotor bears. Deformation of the bearing resulting from a load not being distributed across the entire surface can thereby be prevented. The bearing outer race can also be reinforced around its entire circumference relative to a bearing inner race, that is, e.g., it can have a greater material thickness. This reinforced bearing outer race therefore serves simultaneously as a thermal buffer for the frictional heat produced by the roller bearing. The size of the metallic radiating surface therefore also increases, which means that a lesser amount of the heat produced need be transferred to the plastic.

In an inventive method for manufacturing a device for transmitting a torque, in particular for manufacturing a pulley connected to an internal combustion engine for transmitting a torque from the internal combustion engine to an accessory, a rotor being rotatably connected with a bearing part of a bearing, it is provided that a bearing seat of the rotor is formed in a primary shaping process when the rotor is manufactured. Subsequent machining of the bearing seat can be eliminated. Preferably, a non-positive connection of the rotor with a circumferential surface of the bearing is produced by shrink-fitting the rotor on a bearing part of the bearing, or by shrink-fitting the bearing part of the bearing on the rotor. The manufacture is simple, efficient, and cost-effective, since subsequent machining of a bearing seat in the rotor can be eliminated. Instead, the bearing seat is formed during manufacture of the rotor itself. There is less waste, and separate parts to be inserted during manufacture of the rotor, e.g., the roller bearing, can be eliminated, because the roller bearing is not inserted until the rotor is manufactured. The rotor preferably contacts the bearing on its circumferential surface with ribs, which serve as supporting structures.

In an advantageous embodiment, recesses of the rotor are filled with an adhesive on its side facing the bearing part of the bearing. The recesses are advantageously formed by the distances between the ribs, which serve as the supporting structure. After the bearing is assembled, the adhesive can be injected into the recesses between the ribs. Ventilation channels can be provided on the side opposite to the filling area, which facilitate and/or accelerate ventilation of the filled recess and simultaneously make visual inspection of the adhesion possible.

The device is advantageously manufactured using two techniques, each of which has a special function. The shrink-fitting of the rotor on the bearing—together with appropriate sizing—ensures that the non-positive contact between the rotor and the bearing is maintained over the entire temperature range of use.

The rotor is preferably manufactured in a primary shaping process via injection moulding or compression moulding, or core moulding. As such, a weight advantage is associated with simultaneous, simple manufacture. A profiling of the rotor on its contact surface with a bearing can be attained with relatively simple tools, without the need to insert parts, such as metal bushings or ball bearings in the tool. This simplifies the tool design and, mainly, the injection-moulding process, which can therefore be carried out more reliably and with a shorter cycle time. The entire assembly of the bearing, e.g., pressing in the bearing, applying the adhesive, allowing the adhesive to harden, can be carried out efficiently and cost-effectively. Subsequent material-removal of the bearing seat can be eliminated.

The device is advantageously dimensioned such that a maximum load—created via different thermal expansion coefficients of the bearing part of the bearing and the rotor—on the bearing is attained at a minimum application temperature. With a preferred design, in which the rotor surrounds the bearing, the thermal expansion coefficient of the rotor is greater than that of the bearing. Advantageously, the bearing seat is designed such that damage to the rotor caused by thermal tensions that occur in the material is prevented. Advantageously, the bearing—particularly a bearing race in contact with the rotor—is designed such that [the load] created by the pressure, which is caused by the different thermal expansion coefficients, remains below a permissible limiting value, thereby advantageously influencing the functionality and service life of the roller bearing.

Advantageously, a minimum load—created via different thermal expansion coefficients of the bearing part of the bearing and the rotor—on the bearing is attained at a maximum application temperature. For the minimal load, a design must be selected that ensures that the rotor and bearing do not become separated. Transfer of radial forces between the rotor and the bearing part of the bearing is therefore always ensured.

The present invention is suited for use with pulleys, which are used to drive an air conditioning compressor in a motor vehicle. It can be used, preferably, for rotors that are connected in the interior with a body that has a different thermal expansion coefficient than the rotor, and in cases in which strong radial forces but relatively small axial forces and torques need to be transferred.

### DRAWING

Further embodiments, aspects and advantages of the present invention also result independently of their wording in the claims, without limitation to generality, from exemplary embodiments of the present invention presented below with reference to the drawing.

FIGS. 1a, b show a sectional side view through a rotor after its manufacture (a), and a sectional view along the line IB-IB (b);

FIGS. 2a, b show a sectional side view through a rotor with pressed-in bearing part of the roller bearing (a), and a sectional view along the line IIB-IIB (b); and

FIGS. 3a, b, c show a cross-section through a rotor with inserted bearing part (a), a cross-section along line IIIB-IIIB (b), and a detailed view of the section in the region of an adhesive bond (c).

### DETAILED DESCRIPTION OF THE EXEMPLARY EMBODIMENT

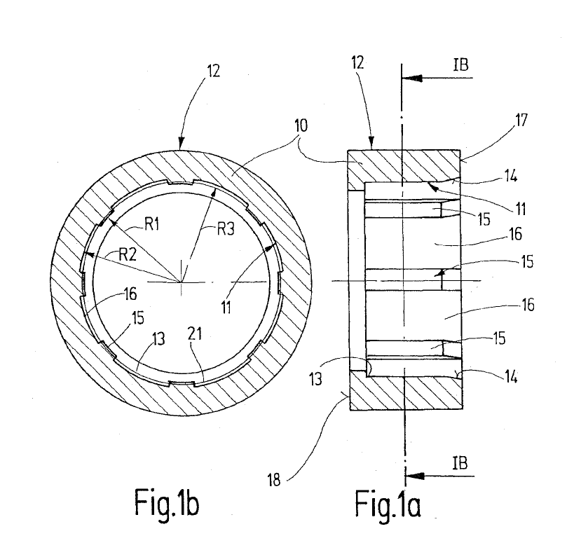

FIGS. 1a, b elucidate the present invention with reference to a sectional side view through a rotor 10 after its manufacture (FIG. 1a), and a cross-section along the line IB-IB (FIG. 1b). Rotor 10 has an inner side 11 provided with ribs 15; recesses 16 are formed between ribs 15. A bevel 14 is provided on the front side 17 of rotor 10, which simplifies insertion of a not-shown roller bearing. In the region of its rear side 18, the size of the inner diameter is reduced by a projection 13. In the region of ribs 15, rotor 10 includes a first radius R1 and, in the region of recesses 16, a larger, second radius R2. An inserted, not-shown inner part would have an external radius R3, which is greater than radius R1, but smaller than R2. This is indicated by a thin line. The dimensions are such that rotor 10 can be shrink-fitted on an inner part of this type, to create a non-positive connection. The inner part can be, e.g., a roller bearing, in particular a ball bearing or its outer bearing race. On its outer side 12, a belt drive or the like can be provided, to drive rotor 10. Only a few ribs 15 and recesses 16 are labeled with reference numerals.

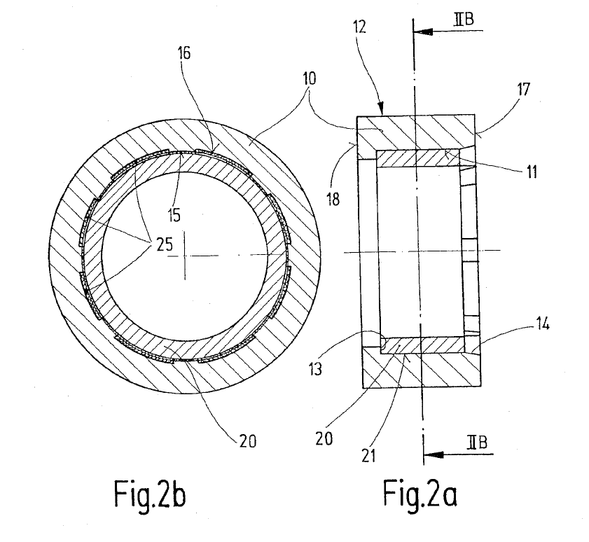

FIGS. 2a and 2b illustrate the situation with a rotor 10 shrink-fitted on a bearing part 20. FIG. 2a shows a cross-sectional side view through rotor 10 with a pressed-in bearing part 20 of a roller bearing, e.g., a ball bearing. FIG. 2b shows a cross-section along the line IIB-IIB. Roller bearing itself is not shown. Rather, it is indicated by bearing part 20, which is designed as a bearing race. Bearing part 20 can be, e.g., the outer bearing race of a roller bearing composed of two bearing races which can be rotated relative to each other. Similar elements are labeled with the same reference numerals as in FIG. 1.

On its side 11 facing bearing part 20, rotor 10 includes ribs 15, which are positioned separately around the circumference and point toward the bearing part 20. Ribs 15, as support structures, ensure a non-positive connection between rotor 10 and the roller bearing in the shrink-fitted state.

Advantageously, bearing includes a reinforced bearing outer race 20, to prevent possible deformation of the outer race due to the load not being distributed across the entire surface by ribs 15 of rotor 10. The bearing outer race has a greater material thickness compared to the not-shown bearing inner race. In the rib area, in which the radial forces are absorbed in particular, the bearing outer race could otherwise become deformed, which could result in impairment of the functionality of the bearing. This reinforced bearing outer race therefore serves simultaneously as a thermal buffer for the frictional heat produced by the bearing.

An adhesive bond 25 is formed between rotor 10 and a circumferential surface 21 of the roller bearing and its bearing part 20, adhesive bond 25 being located in recesses 16 between ribs 15. In this preferred embodiment, recesses 16 have a wider circumference than ribs 15.

The radial forces are transmitted primarily via ribs 15. These ribs 15 are in direct contact with bearing outer race 20. The bearing seat is designed such that ribs 15 are always in contact with the bearing, at low temperatures and at high temperatures. The different thermal expansion coefficients of metal and plastic are taken into account, so that the radial forces can be absorbed by ribs 15 over the entire temperature range.

The axial forces that hold roller bearing 20 in its axial position are advantageously absorbed mainly via the adhesive bond. To this end, the adhesive is inserted in the pocket-like recesses 16 between ribs 15.

There are basically no limitations on the circumferential surface ratio of recesses and ribs. In a preferred embodiment, the recesses have a wider circumference than the ribs.

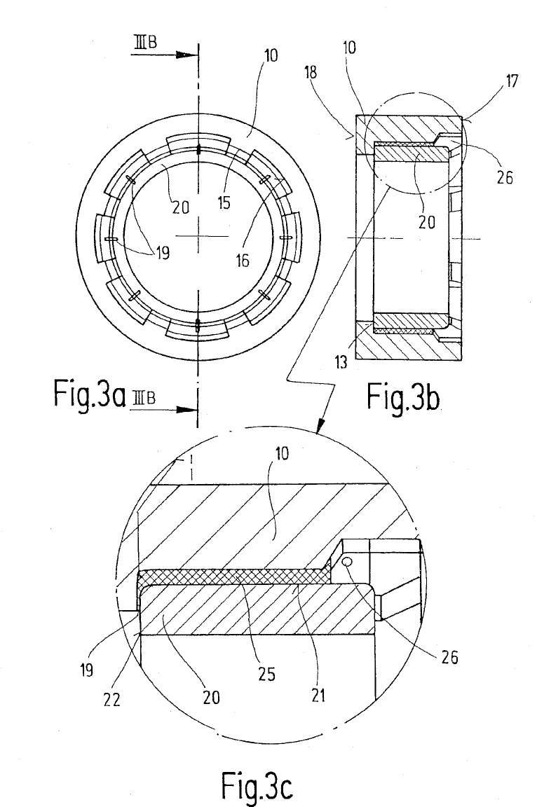

FIGS. 3a, 3b, 3c show a cross-section through a rotor 10 with inserted bearing part 20 (FIG. 3a), a cross-section along line IIIB-IIIB (FIG. 3b), and a detailed view of the section in the region of an adhesive bond 25 (FIG. 3c). Similar elements are labeled with the same reference numerals as in FIGS. 1 and 2.

In the region of its rear side 18, rotor 10 has a projection 13, in the surface of which that faces away from rear side 18 radially oriented ventilation channels 19 designed as grooves are provided. Ventilation channels 19 are located in projection 13 and an underside 22 of bearing part 20. On its diametrically opposed front side 17, the rotor includes expansions 26, which serve as spaces for filling recesses 16 with adhesive. Ventilation channels 19 simplify the filling of the recesses with adhesive and make it possible to monitor the filling. Ventilation channels 19 can have any possible configuration.

With the inventive method for manufacturing a device for transmitting a torque, in particular a pulley connected to an internal combustion engine for transmitting a torque from the internal combustion engine to an accessory, a rotor 10 is rotatably connected with a bearing part 20 of a roller bearing, a non-positive connection of rotor 10 with a circumferential surface 21 of the roller bearing being produced by shrink-fitting rotor 10 on circumferential surface 21. As an alternative, the roller bearing could be shrink-fitted on rotor 10. Rotor 10 is preferably made of plastic. Favorably, the roller bearing is made of metal.

The shape of the bearing seat on inner side 11 of rotor 10 is produced directly in a primary shaping process, in which rotor 10 is manufactured. This preferably takes place with an injection process. Particularly preferably, rotor 10 is manufactured via injection-moulding. As an alternative, rotor 10 can be manufactured via compression moulding or core moulding. It is therefore possible to subsequently temper rotor 10 without stressing the bearing or bearing part 20, which is designed as a bearing outer race. The roller bearing is subsequently pressed into rotor 10. In this process, the roller bearing is inserted into warmed-up rotor 10 at ambient temperature, so that rotor 10 shrink-fits onto the roller bearing or its outer bearing race when it cools. Cracks—which could form in a pressing procedure in the cold state—are therefore prevented from forming.

After the bearing is installed, adhesive is injected into circumferential recesses 16. This can be made easier by the filling spaces in upper region 17 of recesses 16 formed by expansions 26. Ventilation channels 19 diametrically opposed to rear side 18 make it easier and faster to fill recesses 16.

When a thermoset plastic is used, in particular one based on epoxy resin, it is advantageous to apply it to warmed rotor 10, so that the viscosity of the adhesive drops and entire recess 16 can be filled completely with adhesive. In addition, the subsequent hardening time of the adhesive is also reduced, since the warm-up time of rotor 10 is eliminated or at least shortened.

What is claimed is:

1. A device for transmitting a torque, in particular a pulley connected to an internal combustion engine for transmitting a torque from the internal combustion engine to an accessory, a rotor (10) being rotatably connected with a bearing part (20) of a bearing,
wherein
the rotor (10) and a circumferential surface (21) of the bearing part (20) of the bearing are at least partially connected via an adhesive bond (25).

2. The device as recited in claim 1,
wherein
the rotor (10) includes ribs (15) on its side (11) facing the bearing part (20) of the bearing, which are positioned separately around the circumference and point toward the bearing part (20) of the bearing.

3. The device as recited in claim 2,
wherein
the adhesive bond (25) is located in recesses (16) between the ribs (15).

4. The device as recited in claim 2,
wherein
the ribs (15) are connected with the circumferential surface (21) of the bearing part (20) of the bearing in a non-positive manner.

5. The device as recited in claim 2, wherein
the recesses (16) have a wider circumference than the ribs (15).

6. The device as recited in claim 1,
wherein
radii are provided in the side (11) of rotor (10) for transitions from recesses (16) to ribs (15).

7. The device as recited in claim 1, wherein
the bearing part (20) is formed by a bearing outer race of a roller bearing.

8. The device as recited in claim 7,
wherein
the bearing outer race (20) is reinforced relative to a bearing inner race of the roller bearing.

9. A method for manufacturing a device for transmitting a torque, in particular for manufacturing a pulley connected to an internal combustion engine for transmitting a torque from the internal combustion engine to an accessory, a rotor (10) being rotatably connected with a bearing part (20) of a bearing,
wherein
a bearing seat of the rotor (10) is formed in a primary shaping process when the rotor (10) is manufactured.

10. The method as recited in claim 9,
wherein
a non-positive connection of the rotor (10) with a circumferential surface (21) of the bearing (20) is created by shrink-fitting the rotor (10) on the circumferential surface (21), or by shrink-fitting the circumferential surface (21) on the rotor (10).

11. The method as recited in claim 9,
wherein
the rotor (10) is filled with an adhesive in recesses (16) on its side (11) facing the bearing part (20) of the bearing.

12. The method as recited in claim 9,
wherein
the rotor (10) is manufactured in a primary shaping process via injection moulding, compression moulding, or core moulding.

13. The method as recited in claim 9,
wherein
the device is dimensioned such that a maximum load on the bearing part (20) of the bearing is attained at a minimum application temperature.

14. The method as recited in claim 9,
wherein
the device is dimensioned such that a minimum load on the bearing part (20) of the bearing is attained at a maximum application temperature.
